(19) United States
(12) Patent Application Publication
(10) Pub. No.: US 2006/0111537 A1
(43) Pub. Date: May 25, 2006

(54) Bioabsorbable adhesive compounds

(75) Inventor: Mark Roby, Killingworth, CT (US)

Correspondence Address: UNITED STATES SURGICAL,;A DIVISION OF TYCO HEALTHCARE GROUP LP, 195 MCDERMOTT ROAD, NORTH HAVEN, CT, 06473, US

(73) Assignee: Tyco Healthcare Group LP, Norwalk, CT (US)

(21) Appl. No.: 10/533,041

(22) PCT Filed: Oct. 23, 2003
(86) PCT No.: PCT/US03/33826

§ 371 Date: Dec. 14, 2005

Related U.S. Application Data
(60) Provisional application No. 60/421,881, filed on Oct. 28, 2002.

(51) Int. Cl. C08G 18/00

(52) U.S. Cl. 528/44

(57) ABSTRACT

Bioabsorbable adhesive or sealant suitable for use in medical or surgical applications contain three compounds. The first compound is an isocyanate-endcapped absorbable oligumer. The second compound is a trifunctional compound that is also diisocyanate terminated, or end-capped. The third compound is an aromatic diisocyanate.

### TECHNICAL FIELD

This disclosure relates to bioabsorbable compounds and compositions useful as surgical adhesives and sealants.

### DESCRIPTION OF THE RELATED ART

In recent years there has developed increased interest in replacing or augmenting sutures with adhesive bonds. The reasons for this increased interest include: (1) the potential speed with which repair might be accomplished; (2) the ability of a bonding substance to effect complete closure, thus preventing seepage of fluids; and (3) the possibility of forming a bond without excessive deformation of tissue.

Studies in this area, however, have revealed that, in order for surgical adhesives to be accepted by surgeons, they must possess a number of properties. First, they must exhibit high initial tack and an ability to bond rapidly to living tissue. Secondly, the strength of the bond should be sufficiently high to cause tissue failure before bond failure. Thirdly, the adhesive should form a bridge, preferably a permeable flexible bridge. Fourthly, the adhesive bridge and/or its metabolic products should not cause local histotoxic or carcinogenic effects.

A number of adhesive systems such as alkyl cyanoacrylates, polyacrylates, maleic anhydride/methyl vinyl ethers, epoxy systems, polyvinyl alcohols, formaldehyde and gluteraldehyde resins and isocyanates have been investigated as possible surgical adhesives. None has gained acceptance because each fails to meet one or more of the criteria noted above. The principal criticism of these systems has been the potential toxicity problems they pose.

It would be desirable to provide novel metabolically-acceptable bioabsorbable diisocyanate-based adhesives and in particular metabolically-acceptable surgical adhesives. It would also be desirable to provide metabolically-acceptable surgical adhesives which are biodegradable. It would also be desirable to provide a method for closing wounds in living tissue by use of novel, metabolically-acceptable surgical adhesives which are low in toxicity as a consequence of their physical properties.

### SUMMARY

The present compositions, upon curing, provide a bioabsorbable adhesive or sealant suitable for use in medical or surgical applications. These compositions contain three compounds. The first compound is an isocyanate-endcapped absorbable oligomer. To make their first component, an absorbable oligomeric material is prepared by polymerizing one or more hydrolyzable monomers in the presence of a bifunctional or multifunctional initiator. This oligomer is then reacted with an aromatic diisocyanate to terminate, or end-cap, the oligomer. The second compound is a trifunctional compound that is also diisocyanate terminated, or end-capped. The third compound is an aromatic diisocyanate. The three compounds are combined to form the present compositions.

The bioabsorbable compounds and compositions described herein are useful as surgical adhesives and/or sealants for joining portions of body tissue together or for joining surgically implantable devices to body tissue.

### DETAILED DESCRIPTION OF PREFERRED EMBODIMENT(S)

The compositions in accordance with the present disclosure include a) an isocyanate end-capped bioabsorbable oligomer; b) an isocyanate-endcapped trifunctional compound and c) an aromatic diisocyanate.

The first step in preparing the isocyanate end-capped bioabsorbable oligomer of the present composition is to polymerize hydrolyzable monomers in the presence of bi-or multi-functional initiators to prepare a compound, having the following structure:
[A]ₙ−X (II)
wherein A is a bioabsorbable group and is preferably derived from one or more monomers known to form a bioabsorbable polymer, n is from 1 to about 6 and X is a residue from the multifunctional initiator. Suitable monomers from which the bioabsorbable group can be derived include glycolic acid, glycolide, lactic acid, lactide, 1,4-dioxane-2-one, 1,3-dioxane-2-one, ε-caprolactone and the like. Examples of suitable initiators include, but are not limited to, diols, such as, ethylene glycol, diethylene glycol, 1,3-propanediol, 1,4-butanediol, 1,5-pentanediol, 1,6-hexanediol, 1,7-heptanediol, 1,8-octanediol, 1,10-decanediol, 1,12-dodecanediol, 1,2-decanediol, 1,2-dodecanediol, 1,2-hexadecanediol, neopentyl glycol, 3-methyl-1,5-pentanediol, 2-methyl-1,3-propanediol, 2-butyl-2-ethyl-1,3-propanediol, 2-ethyl-3-butyl-1,3-propanediol, 2-ethyl-1,6-hexanediol; aromatic and alkyl triols, such as, for example, glycerol and 1,1,1-trimethylolpropane; polyols, such as neopentyl glycol, and pentaerythritol; alcohol amines, such as triethanolamine, 1-, and 2-aminopropanols, 2- and 4-aminobutanols and the like; dicarboxylic acids such as succinic acid, glutaric acid, adipic acid, suberic acid, sebacic acid, dodecanedioic acid, and 2-ethyl-2-methylsuccinic acid; aromatic dicarboxylic acids, such as phthalic acid, isophthalic acid, and terephthalic acid.

Conditions for polymerizing hydrolyzable monomers in the presence of multifunctional initiators are within the purview or those skilled in the art. For example, the bioabsorbable oligomer can be prepared by drying purified monomer(s) used to form the bioabsorbable oligomer and then polymerizing at temperatures ranging from about 20° C. to about 220° C., preferably above 75° C., in the presence of an organometallic catalyst such as stannous octoate, stannous chloride, diethyl zinc or zirconium acetylacetonate. The polymerization time may range from 1 to 100 hours or longer depending on the other polymerization parameters but generally polymerization times of about 12 to about 48 hours are employed. In addition, a multifunctional initiator is employed. Generally, the amount of initiator used will range from about 0.01 to about 30 percent by weight based on the weight of the monomer. Preferably, the initiator will be present in the reaction mixture in an amount from about 0.5 to about 20 weight percent based on the weight of the monomer.

Once the oligomer is prepared, it is end-capped by reacting With an aromatic diisocyanate. Suitable aromatic diisocyanates include, but are not limited to, 1,4-diisocyanatobenzene, 1,1′-methylenebis[4-isocyanatobenzene], 2,4-diisocyanato-1-methylbenzene, 1,3-diisocyanato-2-methylbenzene, 1,5-diisocyanatonaphthalene, 1,1′-1-methylethylidene)bis[4-isocyanatobenzene) and 1,3- and 1,4-bis(1-isocyanato-1-methylethyl)benzene.

Conditions for reacting hydroxyl-terminated oligomers with aromatic diisocyanates are within the purview of those skilled in the art. The conditions under which the oligomer is reacted with the diisocyanate may vary widely depending on the specific oligomer being endcapped, the specific diisocyanate being employed, and the desired degree of end capping to be achieved. Normally, the polymer is dissolved in a solvent and added dropwise to a solution of the diisocyanate at room temperature with stirring. The amount of diisocyanate employed can range from about 2 to about 8 moles of diisocyanate per mole of oligomer. Suitable reaction times and temperatures range from about 15 minutes to 72 hours or more at temperatures ranging from about 0° C. to 250° C.

Those skilled in the art will readily envision other reaction schemes for preparing useful isocyanate end-capped bioabsorbable oligomers.

The second component of the present compositions is a trifunctional compound that has end-capped with a disocyanate. Suitable trifunctional compounds include but are not limited to aromatic and alkyl triols, such as, for example, glycerol, and trimethylol propane; and alcohol amines, such as triethanolamine, 1-, and 2-aminopropanols, 2- and 4-aminobutanols and the like. The trifunctional compound is preferably glycerol. The trifunctional compound is reacted with a diisocyante. Suitable examples of diisocyanates include, but are not limited to, aromatic polyisocyanates containing 6 to 20 carbon atoms, not including the carbon atoms in the NCO groups, such as o-, m- and p-phenylene diisocyanates (hereinafter referred to as PDI), 2,4- and 2,6-tolylene diisocyanates (TDI), diphenylmethane-2,4′-and 4,4′-diisocyanates (MDI), naphthalene-1,5-diisocyanate, triphenylmethane4,4′,4″-triisocyanate, polymethylene polyphenylenepoly-isocyanates (PAPI) obtained by phosgenation of anilineformidehyde condensation products, m- and p isocyanatophenyl sulfonyl isocyanate, and the like; aliphatic polyisocyanates containing 2 to 18 carbon atoms, such as ethylenediisocyanate, tetramethylenediisocyanate, hexamethylenediisocyanate (hereinafter referred to as HDI), dodecamethylenediisocyanate, 1,6,11-undecane diisocyanate, 2,2,4-trimethylhexanediisocyanate, lysine diisocyanate, 2,6-diisocyanato-methyl caproate, bis(2-isocyanatoethyl fumarate, bis(2-isocyanatoethyl) carbonate, 2-isocyanatoethyl-2,6-diisocyanato hexanoate, and the like; alicyclic polyisocyanates containing 4 to 15 carbon atoms, such as isophorone diisocyanate, dicyclohexylmethane diisocyanates, cyclohexylene diisocyanates, methylcyclohexylene diisocyanates, bis(2-isocyanato-ethyl)4-cyclohexene-1,2-dicarboxylate, and the like; araliphatic polyisocyanates containing 8 to 15 carbon atoms, such as xylylene diisocyanates, diethylbenzene diisocyanates, and the like; and modified polyisocyanates of these polyisocyanates, containing urethane, carbodiimide, allophanate, urea, biuret, urethdione, urethimine, isocyanurate and/or oxazolidone groups, such as urethane-modified TDI, carbodiimide-modified MDI, urethane-modified MDI, and the like; as well as mixtures of two or more of them. Among these polyisocyanates, preferred are aromatic polyisocyanates (preferably diisocyanates), particularly PDI, TDI (including the 2,4- and 2,6-isomers, mixtures of them and crude TDI), MDI (including the 4,4′- and 2,4′-isomers, mixtures of them and crude MDI or PAPI), and modified polyisocyanates containing urethane, carbodiimide, allophanate, urea, biuret and/or isocyanurate groups, derived from PDI, TDI and/or MDI.

Reaction conditions suitable for end-capping the trifunctional compound with the diisocyanate are within the knowledge of those skilled in the art. The specific conditions employed will vary depending on a number of factors including the particular trifunctional compound chosen and the particular diisocyanate employed. Typically, a solution of the trifunctional compound is added dropwise to a solution of the diisocyanate at room temperature with stirring. The amount of diisocyanate employed can range from about 2 to about 8 moles of diisocyanate per mole of trifunctional compound. Suitable reaction times and temperatures range from about 15 minutes to 72 hours or more at temperatures ranging from about 0° C. to 250° C.

The third component of the present compositions is an aromatic diisocyanate compound. A non-exhaustive list of suitable diisocyanate compounds is provided above with respect to the preparation of the first two components.

The relative proportions of the three components in weight percent based on the total weight of the composition is set forth in the following table.

| Component | General Range | Preferred Range |
|---|---|---|
| End-capped Oligomer | 50 to 95% | 70 to 90% |
| End-capped | 5 to 40% | 8 to 25% |
| Trifunctional Compound | | |
| Aromatic Diisocyanate | 1 to 10% | 2 to 5% |

The present compositions can be prepared by simply mixing the three components together with stirring. Care should be taken not to contact the composition with water to avoid pre-mature crosslinking and the resulting thickening of the composition.

Upon crosslinking, the present bioabsorbable compounds can be used as tissue adhesives or sealants. Cross-linking is normally performed by exposing the composition to water, optionally in the presence of a catalyst.

The exact reaction conditions for achieving cross-linking will vary depending on a number of factors such as the particular bioabsorbable oligomer employed, the particular trifunctional compound employed, the particular aromatic diisocyanate employed and the relative amounts of the three components in the composition. Normally, the cross-linking reaction is conducted at temperatures ranging from 20° C. to about 40° C. for thirty seconds to about one hour or more. The amount of water employed will normally range from about 0.05 moles to 1 moles per mole of bioabsorbable compound. While water is a preferred reactant to effect cross-linking it should be understood that other compounds could also be employed either together with or instead of water. Such compounds include diethylene glycol and polyethylene glycol. When present, suitable catalysts for use in the cross-linking reaction include 1,4 diazobicyclo [2.2.2]octane, triethylamine, and diethylaminoethanol. The amount of catalyst employed can range from about 0.005 grams to about 5.0 grams per kilogram of compound being cross-linked.

When the present composition is intended for implantation it is possible to effectuate cross-linking in situ using the water naturally present in a mammalian body or with added water. However, to more precisely control the conditions and extent of cross-linking, it may be advantageous to partially cross-link the compound prior to its use as an implant.

The bioabsorbable compounds and compositions described herein are advantageously useful as a surgical adhesive or sealant, for example, for joining portions of body tissue together, or for adhering a surgical device such as a surgical mesh, fastener, implant, etc., to soft body tissue.

It will be understood that various modifications may be made to the embodiments disclosed herein. For example, the compositions in accordance with this disclosure can be blended with other biocompatible, bioabsorbable or non-bioabsorbable materials. As another example, optional ingredients such as dyes, fillers, medicaments or antimicrobial compounds can be added to the composition. Therefore, the above description should not be construed as limiting, but merely as exemplifications of preferred embodiments. Those skilled in art will envision other modifications within the scope and spirit of the claims appended hereto.

What is claimed is:

1. A composition comprising:
a bioabsorbable oligomeric compound that is end-capped with an aromatic diisocyanate;
a trifunctional compound that is end-capped with an aromatic diisocyanate; and
an aromatic diisocyanate.

2. A composition as in claim 1 wherein the bioabsorbable oligomeric compound is a compound having the structure:
[A]ₙ−X
wherein A is a bioabsorbable group, n is from 1 to about 6 and X is a residue from a multifunctional initiator.

3. A composition as in claim 2 wherein the bioabsorbable group is a group derived from a monomer selected from the group consisting of glycolic acid, glycolide, lactic acid, lactide, 1,4-dioxane-2-one, 1,3-dioxane-2-one and ε-caprolactone.

4. A composition as in claim 2 wherein X is a residue from a multifunctional initiator selected from the group consisting of diols, aromatic and alkyl triols, polyols, alcohol amines, dicarboxylic acids and aromatic dicarboxylic acids.

5. A composition as in claim 2 wherein X is a residue from a multifunctional initiator selected from the group consisting of ethylene glycol, diethylene glycol, 1,3-propanediol, 1,4-butanediol, 1,5-pentanediol, 1,6-hexanediol, 1,7-heptanediol, 1,8-octanediol, 1,10-decanediol, 1,12-dodecanediol, 1,2-decanediol, 1,2-dodecanediol, 1,2-hexadecanediol, neopentyl glycol, 3-methyl-1,5-pentanediol, 2-methyl-1,3-propanediol, 2-butyl-2-ethyl-1,3-propanediol, 2-ethyl-3-butyl-1,3-propanediol, 2-ethyl-1,6-hexanediol, glycerol, 1,1,1-trimethylolpropane, neopentyl glycol, pentaerythritol, triethanolamine, 1- aminopropanols, 2-aminopropanols, 2- aminobutanols, 4-aminobutanols, succinic acid, glutaric acid, adipic acid, suberic acid, sebacic acid, dodecanedioic acid, 2-ethyl-2-methylsuccinic acid, phthalic acid, isophthalic acid, and terephthalic acid.

6. A composition as in claim 1 wherein the bioabsorbable oligomer is end-capped with an aromatic diisocyanate selected from the group consisting of 1,4-diisocyanatobenzene, 1,1′-methylenebis[4-isocyanatobenzene], 2,4-diisocyanato-1-methylbenzene, 1,3-diisocyanato-2-methylbenzene, 1,5-diisocyanatonaphthalene, 1,1′-(1-methylethylidene)bis[4-isocyanatobenzene) and 1,3- and 1,4-bis(1-isocyanato-1-methylethyl)benzene.

7. A composition as in claim 1 wherein the trifunctional compound is selected from the group consisting of glycerol, 1,1,1-trimethylolpropane, neopentyl glycol, pentaerythritol, triethanolamine, 1- aminopropanols, 2-aminopropanols, 2- aminobutanols, 4-aminobutanols.

8. A composition as in claim 1 wherein the trifunctional compound is end-capped with an aromatic diisocyanate selected from the group consisting of 1,4-diisocyanatobenzene, 1,1′-methylenebis[4-isocyanatobenzene], 2,4-diisocyanato-1-methylbenzene, 1,3-diisocyanato-2-methylbenzene, 1,5-diisocyanatonaphthalene, 1,1′-(1-methylethylidene)bis[4-isocyanatobenzene) and 1,3- and 1,4-bis(1-isocyanato-1-methylethyl)benzene.

9. A composition as in claim 1 wherein the aromatic diisocyanate is selected from the group consisting of 1,4-diisocyanatobenzene, 1,1′-methylenebis[4-isocyanatobenzene], 2,4-diisocyanato-1-methylbenzene, 1,3-diisocyanato-2-methylbenzene, 1,5-diisocyanatonaphthalene, 1,1′-(1-methylethylidene)bis[4-isocyanatobenzene) and 1,3- and 1,4-bis(1-isocyanato-1-methylethyl)benzene.

10. (canceled)

11. (canceled)

12. (canceled)

13. A composition as in claim 1 wherein the bioabsorbable oligomeric compound that is end-capped with an aromatic diisocyanate is present in an amount from about 50 to about 95 percent by weight of the composition;
the trifunctional compound that is end-capped with an aromatic diisocyanate is present in an amount from about 5 to about 40 percent by weight of the composition; and
the aromatic diisocyanate is present in an amount from about 1 to about 10 percent by weight of the composition.

14. A composition as in claim 1 wherein the bioabsorbable oligomeric compound that is end-capped with an aromatic diisocyanate is present in an amount from about 70 to about 90 percent by weight of the composition;
the trifunctional compound that is end-capped with an aromatic diisocyanate is present in an amount from about 8 to about 25 percent by weight of the composition; and
the aromatic diisocyanate is present in an amount from about 2 to about 5 percent by weight of the composition.

15. A method of adhering first and second tissue surfaces, the method comprising approximating the first and second tissue surfaces; and applying to the approximated tissue surfaces a composition of claim 1.

16. A method of adhering a surgical device to tissue, the method comprising: applying to the surgical device a composition of claim 1; and contacting the surgical device with tissue.

17. A method of sealing a defect in tissue, the method comprising identifying a tissue site containing a defect; and applying a composition of claim 1 to the site of the defect.

18. A method for reducing leakage of bodily fluids or air comprising applying to a tissue defect a composition in accordance with claim 1 and crosslinking the composition.

19. A composition comprising:
a bioabsorbable oligomeric compound that is end-capped with an aromatic diisocyanate, wherein the bioabsorbable oligomeric compound has the structure:
[A]ₙ−X
wherein A is a bioabsorbable group derived from a monomer selected from the group consisting of glycolic acid, glycolide, lactic acid, lactide, 1,4-dioxane-2-one, 1,3-dioxane-2-one and ε-caprolactone, n is from about 1 to about 6 and X is a residue from a multifunctional initiator selected from the group consisting of ethylene glycol, diethylene glycol, 1,3-propanediol, 1,4-butanediol, 1,5-pentanediol, 1,6-hexanediol, 1,7-heptanediol, 1,8-octanediol, 1,10-decanediol, 1,12-dodecanediol, 1,2-decanediol, 1,2-dodecanediol, 1,2-hexadecanediol, neopentyl glycol, 3-methyl-1,5-pentanediol, 2-methyl-1,3-propanediol, 2-butyl-2-ethyl-1,3-propanediol, 2-ethyl-3-butyl-1,3-propanediol, 2-ethyl-1,6-hexanediol, glycerol, 1,1,1-trimethylolpropane, neopentyl glycol, pentaerythritol, triethanolamine, 1- aminopropanols, 2-aminopropanols, 2- aminobutanols, 4-aminobutanols, succinic acid, glutaric acid, adipic acid, suberic acid, sebacic acid, dodecanedioic acid, 2-ethyl-2-methylsuccinic acid, phthalic acid, isophthalic acid, and terephthalic acid;
a trifunctional compound that is end-capped with an aromatic diisocyanate, wherein the trifunctional compound is selected from the group consisting of glycerol, 1,1,1-trimethylolpropane, neopentyl glycol, pentaerythritol, triethanolamine, 1-aminopropanols, 2-aminopropanols, 2-aminobutanols, 4-aminobutanols; and
an aromatic diisocyanate selected from the group consisting of 1,4-diisocyanatobenzene, 1,1′-methylenebis[4-isocyanatobenzene], 2,4-diisocyanato-1-methylbenzene, 1,3-diisocyanato-2-methylbenzene, 1,5-diisocyanatonaphthalene, 1,1′-(1-methylethylidene)bis[4-isocyanatobenzene) and 1,3- and 1,4-bis(1-isocyanato-1-methylethyl)benzene.

20. A method of comprising:
applying to tissue a composition compsrising a bioabsorbable oligomeric compound that is end-capped with an aromatic diisocyanate; a trifunctional compound that is end-capped with an aromatic diisocyanate; and an aromatic diisocyanate; and crosslinking the composition.

21. A method as in claim 17 wherein crosslinking comprises contacting the composition with a compound selected from the group consisting of water, diethylene glycol and polyethylene glycol.

22. A method as in claim 17 wherein crosslinking includes the use of a catalyst.

23. A method as in claim 17 wherein crosslinking is conducted at temperatures from about 20° C. to about 40° C. for a time from about thirty seconds to about one hour.

24. A method as in claim 17 wherein crosslinking is conducted at least partially prior to application to tissue.
